(19) United States
(12) Patent Application Publication
(10) Pub. No.: US 2012/0317039 A1
(43) Pub. Date: Dec. 13, 2012

(54) ON-DEMAND PURCHASE OF VIRTUAL IMAGE LICENSES IN A CLOUD COMPUTING ENVIRONMENT

(75) Inventors: Todd E. Kaplinger, Raleigh, NC (US); Aaron K. Shook, Raleigh, NC (US); Ian N. Whalley, Yorktown Heights, NY (US)

(73) Assignee: INTERNATIONAL BUSINESS MACHINES CORPORATION, Armonk, NY (US)

(21) Appl. No.: 13/158,373

(22) Filed: Jun. 11, 2011

(51) Int. Cl. G06Q 50/00

(52) U.S. Cl. 705/310

(57) ABSTRACT

On-demand purchase of one or more virtual image licenses when a requested virtual image placement into a cloud computing environment is (or will be) denied because sufficient license capacity is not currently available with existing licenses. Particular users are authorized in advance for on-demand purchase of new licenses for virtual image placement, and the purchase for such users occurs automatically upon detecting that the enterprise for which the placement is requested does not have sufficient license capacity. If the user requesting the placement is not authorized for on-demand license purchase, a purchase request is preferably sent automatically to a license administrator with the needed purchase authority, and the placement request is queued and then subsequently restarted when the license purchase completes.

### CROSS-REFERENCE TO RELATED APPLICATION

The present application is related to commonly-assigned and co-pending application Ser. No. 12/791,353, “System and Method for Management of License Entitlements in a Virtualized Environment” (hereinafter, “the related application”), which was filed on Jun. 1, 2010 and which is hereby incorporated herein by reference as if set forth fully.

### BACKGROUND

The present invention relates to computing systems, and deals more particularly with on-demand purchase of virtual image licenses in a cloud computing environment.

Cloud computing has gained tremendous popularity in recent years. Cloud computing provides a collaborative computing model where computing resources are deployed in a widely-available computing network such as the Internet or World-Wide Web. The computing resources may comprise software applications as well as data stores. Accordingly, a cloud computing environment (referred to equivalently herein simply as a cloud) may be configured to provide application services and information services to users.

### BRIEF SUMMARY

The present invention is directed to placing a virtual image into a cloud computing environment. In one aspect, this comprises: determining, for each of at least one license required for placement of a virtual image into a cloud computing environment, whether the license has sufficient available capacity for the placement of the virtual image; for each of at least one of the required licenses which is determined to not have sufficient available capacity for the placement, evaluating whether a user making a placement request for the placement of the virtual image into the cloud computing environment was previously authorized for on-demand purchase of the license; and for each required license for which the evaluating determines that the user was previously authorized for the on-demand purchase, automatically issuing a purchase request to purchase the license.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 provides a flowchart depicting logic which may be used by an embodiment of the present invention;

FIG. 2 depicts a data processing system suitable for storing and/or executing program code; and

FIG. 3 depicts a representative networking environment in which one or more embodiments of the present invention may be used.

### DETAILED DESCRIPTION

Embodiments of the present invention are directed to on-demand purchase of virtual image licenses when a requested virtual image placement is denied because sufficient license capacity is not currently available with existing licenses, as will now be discussed.

A virtual image, as that term is used herein, is a collection comprising one or more software resources which has been constructed and configured as an invocable solution. The virtual image may then be provisioned (i.e., deployed) to a cloud computing environment where it can be invoked by users. A virtual image may alternatively be referred to as a virtual machine.

Provisioning of virtual images in a cloud computing environment is facilitated by products such as the WebSphere® CloudBurst™ product from International Business Machines Corporation. (“WebSphere” is a registered trademark, and “CloudBurst” is a trademark, of International Business Machines Corporation in the United States, other countries, or both.) CloudBurst enables information technology (“IT”) professionals to deploy virtual systems into a cloud with a click of a button, and also enables the IT professionals to manage virtual systems once they have been deployed.

While provisioning of virtual images into a cloud computing environment may be done with click-of-a-button ease, systems administrators remain responsible for the difficult task of managing available licenses for products used by the virtual images. As ease of provisioning continues to increase, more users will be deploying virtual images to a cloud computing environment. Monitoring an allotment of licenses to determine whether available license capacity has already been fully consumed therefore becomes increasingly difficult.

It may also happen that a virtual image to be deployed has a dependency on one or more other virtual images that are part of the same topology as the virtual image to be deployed. For example, an operating system virtual image is typically deployed in advance of software virtual images that depend on using the operating system. There may be dependencies among the software virtual images as well. For example, a particular topology may include an application server and a database, and the an application server may be dependent upon using the database.

The related application discusses a number of issues and considerations that arise when evaluating license availability, and reference may be made to the related application for further background information.

As is known in the art, the process of deploying a virtual image into a cloud computing environment is also referred to as “placement” of the virtual image into the cloud. Tools are known in the art for determining how many licenses are currently in use for an existing placement. One such tool is the IBM® License Metric Tool from International Business Machines Corporation. (“IBM” is a registered trademark of International Business Machines Corporation in the United States, other countries, or both.) Tools are also known in the art for determining whether sufficient license capacity exists for a candidate placement, and one example is the above-noted WebSphere CloudBurst product. A tool for evaluating a candidate placement in terms of available license capacity may, for example, consult a table or other data structure that stores information about license requirements of products included in a particular virtual image and may also consult a data structure that stores information about a collection of licenses which have been paid for by the deploying enterprise and the current usage of those licenses. Rules and/or program logic may be used for evaluating a placement in addition to, or instead of, using information stored in data structures.

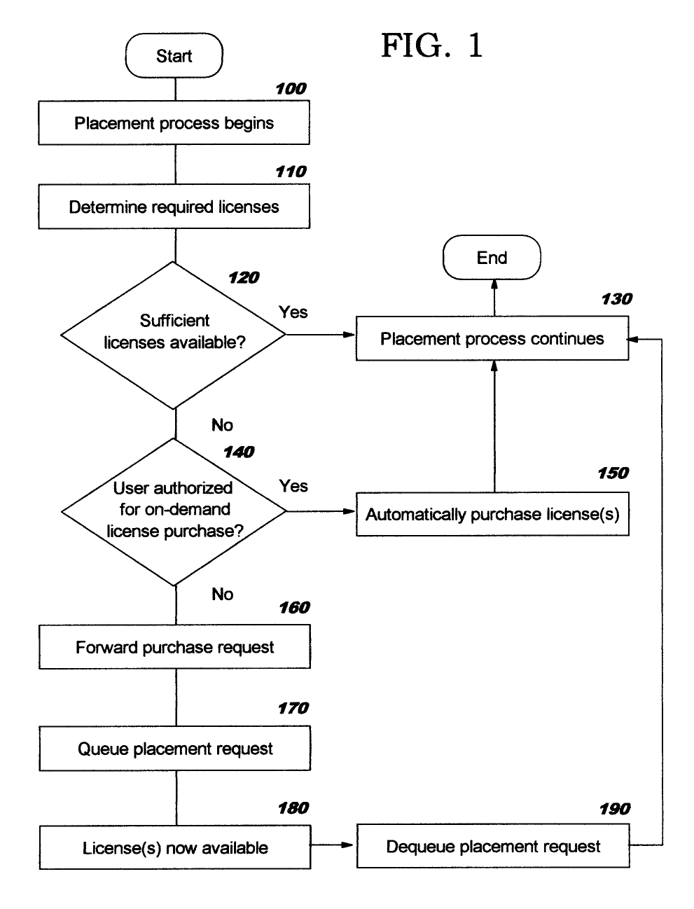

Reference is now made to FIG. 1, which provides a flowchart depicting logic which may be used by an embodiment of the present invention. Processing shown therein comprises carrying out on-demand purchase of virtual image licenses when a requested virtual image placement is (or will be) denied because sufficient license capacity is not currently available with existing licenses.

The placement process begins (Block 100) with a user's request for placement of a virtual image into a cloud. Licenses required for placement of this virtual image into the cloud are determined (Block 110), using techniques which are outside the scope of the present invention. In one approach, this determination comprises using a tool that is designed for evaluating a candidate placement, such as the License Metric Tool which was discussed earlier.

Block 120 tests whether sufficient license capacity is available for this requested placement, using existing licenses. If the test in Block 120 has a positive result, then the placement process for the virtual image continues, as shown at Block 130. Otherwise, the processing of FIG. 1 continues at Block 140.

It should also be noted that while discussions herein refer primarily to placement of “a” virtual image, this is by way of illustration and not of limitation. A single user deployment action might alternatively comprise the placement of multiple virtual images, each of which may have one or more licensing requirements. In such cases where multiple virtual images are being placed in a single deployment, if the licensing requirement for any virtual image in the deployment is not met, then this preferably triggers the “No” branch of the test at Block 120 for the entire deployment. It will be obvious to one of ordinary skill in the art, given the teachings provided herein, how the processing of FIG. 1 can be altered to accommodate this processing.

According to an embodiment of the present invention, particular users are authorized in advance for purchasing new licenses via a cloud management system. A data structure may be created, for example, that stores information indicating which users have this on-demand purchase authorization, and the particular license(s) that each user is authorized to purchase. Block 140 therefore tests whether the user requesting the current placement is authorized to purchase the license(s) needed for the placement. If the test at Block 140 has a positive result, then an on-demand license purchase is automatically carried out, as shown at Block 150, allowing the placement process for the virtual image to immediately continue at Block 130 as if the needed licenses had already been available.

The processing that automatically carries out the on-demand license purchase at Block 150 comprises, in a preferred approach, consulting a data store that has been configured with information needed for issuing a purchase request for a license. This information may comprise, by way of illustration but not of limitation, an address of a license server to which a purchase request can be sent electronically; billing information to be included with the purchase request; and delivery information for returning a purchase acknowledgement or receipt.

It may happen that the virtual image to be deployed has a topology that contains a plurality of different types of licenses. The placement requires sufficient available capacity for each of the licenses in order for the test in Block 120 to have a positive result. In addition, the requesting user must be authorized for on-demand purchase of each different license which does not have sufficient capacity in order for the test in Block 140 to have a positive result.

It may happen that the user requesting the virtual image placement has not been authorized in advance for purchasing the needed license(s). In this case, the processing of FIG. 1 continues at Block 160 following a negative result at Block 140. According to a preferred embodiment of the present invention, a purchase request for the needed license(s) is automatically sent to a licensing administrator who is allowed to purchase additional licenses, as shown at Block 160. In an alternative approach, the user requesting the placement may be prompted to create a purchase approval request following a negative result at Block 140 and prior to the processing of Block 160. In either case, delay in the virtual image placement may be introduced, and an embodiment of the present invention therefore preferably puts the virtual image placement request into a queued state (Block 170).

The purchase request sent to the license administrator at Block 160 preferably identifies the type of license that is needed, and the amount of license capacity which is needed for the virtual image that is to be placed into the cloud. The identification of license type may use information obtained during the processing of Block 110, and the needed amount of license capacity may use information obtained during the processing of Block 120. A data store may be consulted programmatically to determine the license administrator's address to which the purchase request will be sent, where this data store has been configured with such information in advance.

At some point, the system detects that the purchase of the needed license(s) is complete, as shown at Block 180. (Event-driven processing may be used to invoke the processing at Block 180, whereby an event is fired to signal availability of the purchased license(s).) Accordingly, the queued placement request is dequeued (Block 190), allowing the placement process for the virtual image to continue at Block 130. Optionally, the user requesting the placement can be notified that the purchase of the license(s) is complete and that the virtual image placement processing has therefore automatically continued.

The processing which has been described above allows transparent and seamless virtual image placement when the requesting user is authorized for on-demand purchase of any needed license(s). For users who are not authorized for such purchases, the automatic sending of a purchase request to a licensing administrator simplifies the processing that is performed to recover from the denied virtual image placement, particularly when the denied placement request is queued and automatically restarted upon completion of the license purchase (as discussed above with reference to Blocks 170-190 of FIG. 1).

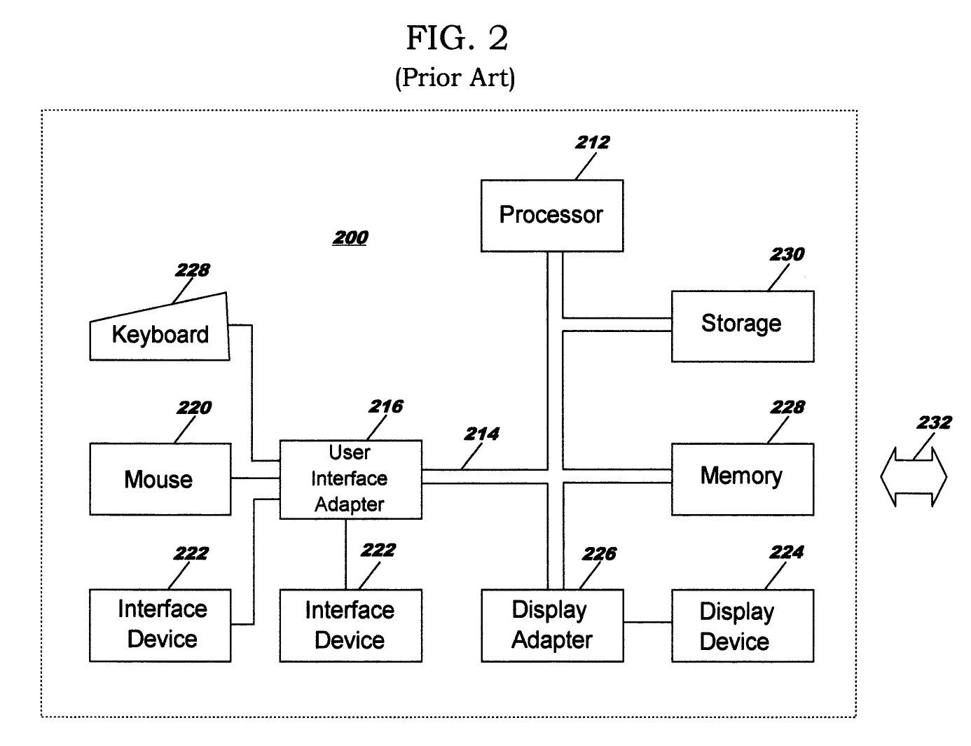

Referring now to FIG. 2, a data processing system 200 suitable for storing and/or executing program code includes at least one processor 212 coupled directly or indirectly to memory elements through a system bus 214. The memory elements can include local memory 228 employed during actual execution of the program code, bulk storage 230, and cache memories (not shown) which provide temporary storage of at least some program code in order to reduce the number of times code must be retrieved from bulk storage during execution.

Input/output (“I/O”) devices (including but not limited to keyboards 218, displays 224, pointing devices 220, other interface devices 222, etc.) can be coupled to the system either directly or through intervening I/O controllers or adapters (216, 226).

Network adapters may also be coupled to the system to enable the data processing system to become coupled to other data processing systems or remote printers or storage devices through intervening private or public networks (as shown generally at 232). Modems, cable modem attachments, wireless adapters, and Ethernet cards are just a few of the currently-available types of network adapters.

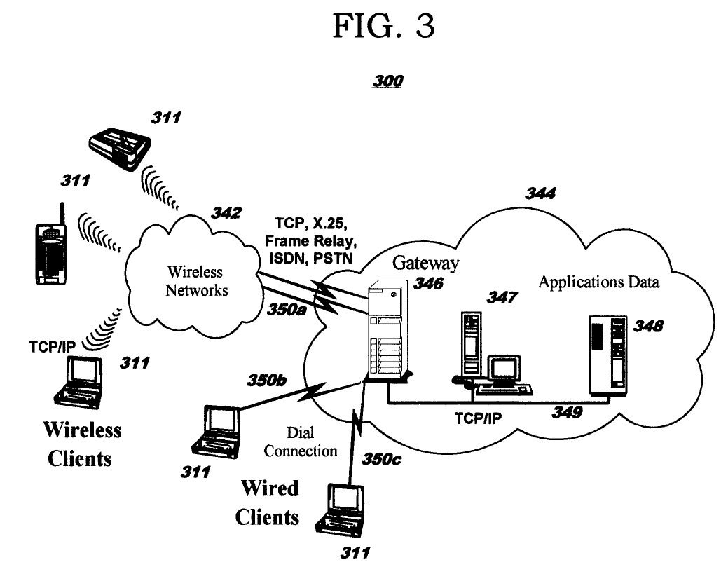

FIG. 3 illustrates a data processing network environment 300 in which the present invention may be practiced. The data processing network 300 may include a plurality of individual networks, such as wireless network 342 and wired network 344. A plurality of wireless devices 310 may communicate over wireless network 342, and a plurality of wired devices, shown in the figure (by way of illustration) as workstations 311, may communicate over network 344. Additionally, as those skilled in the art will appreciate, one or more local area networks (“LANs”) may be included (not shown), where a LAN may comprise a plurality of devices coupled to a host processor.

Still referring to FIG. 3, the networks 342 and 344 may also include mainframe computers or servers, such as a gateway computer 346 or application server 347 (which may access a data repository 348). A gateway computer 346 serves as a point of entry into each network, such as network 344. The gateway 346 may be preferably coupled to another network 342 by means of a communications link 350a. The gateway 346 may also be directly coupled to one or more workstations 311 using a communications link 350b, 350c, and/or may be indirectly coupled to such devices. The gateway computer 346 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 346 may also be coupled 349 to a storage device (such as data repository 348).

Those skilled in the art will appreciate that the gateway computer 346 may be located a great geographic distance from the network 342, and similarly, the workstations 311 may be located some distance from the networks 342 and 344, respectively. For example, the network 342 may be located in California, while the gateway 346 may be located in Texas, and one or more of the workstations 311 may be located in Florida. The workstations 311 may connect to the wireless network 342 using a networking protocol such as the Transmission Control Protocol/Internet Protocol (“TCP/IP”) over a number of alternative connection media, such as cellular phone, radio frequency networks, satellite networks, etc. The wireless network 342 preferably connects to the gateway 346 using a network connection 350a such as TCP or User Datagram Protocol (“UDP”) over IP, X.25, Frame Relay, Integrated Services Digital Network (“ISDN”), Public Switched Telephone Network (“PSTN”), etc. The workstations 311 may connect directly to the gateway 346 using dial connections 350b or 350c. Further, the wireless network 342 and network 344 may connect to one or more other networks (not shown), in an analogous manner to that depicted in FIG. 3.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of placing a virtual image into a cloud computing environment, comprising:
performing, with a processor of a computer, a pre-authorization of a user for placing on-demand purchase requests for each of at least one license for placement of a virtual image into a cloud computing environment; and
responsive to a placement request of the user, performing a placement of the virtual image into the cloud computing environment, using the processor of the computer, comprising:
determining, by the processor of the computer for each of at least one license required for the placement of the virtual image into the cloud computing environment, whether the license has sufficient available capacity for the placement of the virtual image;
for each of at least one of the required licenses which is determined to not have sufficient available capacity for the placement, evaluating, by the processor of the computer, whether the user is pre-authorized for on-demand purchase of the license;
for each required license for which the evaluating determines that the user is pre-authorized for the on-demand purchase, issuing, from the processor of the computer to a license server, a purchase request to purchase the license automatically and without requesting input from any user; and
responsive to determining, by the processor of the computer, that the purchase request is issued for the each required license for which the evaluating determines that the sufficient capacity is not available, causing, by the processor of the computer, the placement of the virtual image to continue automatically, without input of the user.

2. The method according to claim 1, further comprising:
for each required license for which the evaluating determines that the user is not pre-authorized for the on-demand purchase, automatically issuing, by the processor of the computer, a purchase request to an authorized user to request the authorized user to purchase the license.

3. The method according to claim 1, further comprising:
responsive to the evaluating determining that the user is not pre-authorized for the on-demand purchase of at least one of the required licenses which is determined to not have sufficient available capacity for the placement, queuing, by the processor of the computer, the placement request for the placement of the virtual image into the cloud computing environment to await a purchase of each of the at least one of the required licenses.

4. The method according to claim 3, further comprising:
dequeuing, by the processor of the computer, the placement request responsive to determining that the awaited purchase is complete for each of the at least one of the required licenses.

5. The method according to claim 4, wherein the placement of the virtual image continues automatically, responsive to the dequeuing.

6. The method according to claim 2, wherein the authorized user is a license administrator.

7. (canceled)

8. The method according to claim 1, wherein:
a plurality of different license types are needed for the placement of the virtual image; and
the determining, for each of the at least one license required for the placement, whether the license has sufficient available capacity for the placement considers each of the different license types.

9. A system for placing a virtual image into a cloud computing environment, comprising:
a computer comprising a processor; and
instructions which are executable, using the processor, to implement functions comprising:
performing a pre-authorization of a user for placing on-demand purchase requests for each of at least one license for placement of a virtual image into a cloud computing environment; and
responsive to a placement request of the user, performing a placement of the virtual image into the cloud computing environment, comprising:
determining, for each of at least one license required for the placement of the virtual image into the cloud computing environment, whether the license has sufficient available capacity for the placement of the virtual image;
for each of at least one of the required licenses which is determined to not have sufficient available capacity for the placement, evaluating whether the user is pre-authorized for on-demand purchase of the license;
for each required license for which the evaluating determines that the user is pre-authorized for the on-demand purchase, issuing a purchase request to a license server to purchase the license automatically and without requesting input from any user; and
responsive to determining that the purchase request is issued for the each required license for which the evaluating determines that the sufficient capacity is not available, causing the placement of the virtual image to continue automatically, without input of the user.

10. The system according to claim 9, wherein the functions further comprise:
for each required license for which the evaluating determines that the user is not pre-authorized for the on-demand purchase, automatically issuing a purchase request to an authorized user to request the authorized user to purchase the license.

11. The system according to claim 9, wherein the functions further comprise:
responsive to the evaluating determining that the user is not pre-authorized for the on-demand purchase of at least one of the required licenses which is determined to not have sufficient available capacity for the placement, queuing the placement request for the placement of the virtual image into the cloud computing environment to await a purchase of each of the at least one of the required licenses; and
dequeuing the placement request responsive to determining that the awaited purchase is complete for each of the at least one of the required licenses.

12. The system according to claim 11, wherein the placement of the virtual image continues automatically, responsive to the dequeuing.

13. (canceled)

14. The system according to claim 9, wherein:
a plurality of different license types are needed for the placement of the virtual image; and
the determining, for each of the at least one license required for the placement, whether the license has sufficient available capacity for the placement considers each of the different license types.

15. A computer program product for placing a virtual image into a cloud computing environment, the computer program product comprising:
a computer readable storage medium having computer readable program code embodied therein, the computer readable program code configured for:
performing a pre-authorization of a user for placing on-demand purchase requests for each of at least one license for placement of a virtual image into a cloud computing environment; and
responsive to a placement request of the user, performing a placement of the virtual image into the cloud computing environment, comprising:
determining, for each of at least one license required for the placement of the virtual image into the cloud computing environment, whether the license has sufficient available capacity for the placement of the virtual image;
for each of at least one of the required licenses which is determined to not have sufficient available capacity for the placement, evaluating whether the user is pre-authorized for on-demand purchase of the license;
for each required license for which the evaluating determines that the user is pre-authorized for the on-demand purchase, issuing a purchase request to a license server to purchase the license automatically and without requesting input from any user; and
responsive to determining that the purchase request is issued for the each required license for which the evaluating determines that the sufficient capacity is not available, causing the placement of the virtual image to continue automatically, without input of the user.

16. The computer program product according to claim 15, wherein the computer readable program code is further configured for:
for each required license for which the evaluating determines that the user is not pre-authorized for the on-demand purchase, automatically issuing a purchase request to an authorized user to request the authorized user to purchase the license.

17. The computer program product according to claim 15, wherein the computer readable program code is further configured for:
responsive to the evaluating determining that the user is not pre-authorized for the on-demand purchase of at least one of the required licenses which is determined to not have sufficient available capacity for the placement, queuing the placement request for the placement of the virtual image into the cloud computing environment to await a purchase of each of the at least one of the required licenses; and
dequeuing the placement request responsive to determining that the awaited purchase is complete for each of the at least one of the required licenses.

18. The computer program product according to claim 17, wherein the placement of the virtual image continues automatically, responsive to the dequeuing.

19. (canceled)

20. The computer program product according to claim 15, wherein:
a plurality of different license types are needed for the placement of the virtual image; and
the determining, for each of the at least one license required for the placement, whether the license has sufficient available capacity for the placement considers each of the different license types.
